(19) United States
(12) Patent Application Publication
(10) Pub. No.: US 2021/0026130 A1
(43) Pub. Date: Jan. 28, 2021

(54) MENU MAGNIFYING AND ILLUMINATING DEVICE

(71) Applicant: Arvett Bradford, South Glastonbury, CT (US)

(72) Inventor: Arvett Bradford, South Glastonbury, CT (US)

(21) Appl. No.: 16/934,659

(22) Filed: Jul. 21, 2020

Related U.S. Application Data
(60) Provisional application No. 62/876,774, filed on Jul. 22, 2019.

(51) Int. Cl. G02B 25/02; G02B 25/00

(52) U.S. Cl. CPC G02B 25/02; G02B 25/005

(57) ABSTRACT

The menu magnifying and illuminating device is a small handheld magnifying tool, designed to assist with reading small/fine print on restaurant menus. The menu magnifying and illuminating device is preferably shaped similarly to a smartphone, so as to fit easily into a pocket or bag and includes a wide magnifying screen for reading text. LED lights are optionally installed around the interior perimeter in order to illuminate the text when reading in dim restaurant lighting. A user simply slides the menu magnifying and illuminating device over a menu to magnify the small text and clearly read all menu options.

### CROSS-REFERENCE TO RELATED APPLICATION

The present application is related to and claims priority from prior provisional application Ser. No. 62/876,774, filed Jul. 22, 2019, the entire application of which is incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of magnifying devices. More specifically, the invention is a portable tool designed to magnify and illuminate a restaurant menu, allowing users to easily see the small text on a menu even in low lighting situations.

### 2. Description of the Related Art

Reading small, fine print on restaurant menus can be immensely difficult for some people. Restaurant lighting is often dim, and people with poor eyesight may lack the ability to clearly read the menu. When unable to read the menu, people may be unable to make food choices, accidentally order something that includes an ingredient they don't like, or be forced to ask their server to read or summarize the menu. This can be time consuming, taking the server away from other tables, and embarrassing for the person with poor eyesight.

Ideally, a menu magnifying and illuminating device should provide an easy way to magnify and illuminate a menu or other printed material and, yet would operate reliably and be manufactured at a modest expense. Thus, a need exists for a reliable menu magnifying and illuminating device to avoid the above-mentioned problems.

### BRIEF SUMMARY OF THE INVENTION

In view of the foregoing disadvantages inherent in the known magnifying device art, the present invention provides a novel menu magnifying and illuminating device. The general purpose of the present invention, which will be described subsequently in greater detail is to provide an easy way for a user to read and understand menu choices.

The menu magnifying and illuminating device magnifies and illuminates a restaurant menu, allowing users to see the small text on a menu despite the limited lighting that is often available in a restaurant setting. The presently claimed invention includes a wide magnifying screen that magnifies small text, and light emitting diode (LED) lights along the inner perimeter of the magnifying screen that illuminate the magnified text to make reading easier.

The present invention holds significant improvements and serves as a menu magnifying and illuminating device. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention that are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures that accompany the written portion of this specification illustrate embodiments and method(s) of use for the present invention, a menu magnifying and illuminating device, constructed and operative according to the teachings of the present invention.

FIG. 1 shows a perspective view illustrating a user using the menu magnifying and illuminating device, according to an embodiment of the presently claimed invention.

FIG. 2 is a perspective view illustrating two angles of the menu magnifying and illuminating device, according to an embodiment of the presently claimed invention.

FIG. 3 is a close-up view illustrating the menu magnifying and illuminating device, according to an embodiment of the presently claimed invention of FIG. 2.

FIG. 4 is a perspective view illustrating a text as seen through the menu magnifying and illuminating device, according to an embodiment of the presently claimed invention.

FIG. 5 is a perspective view illustrating how the menu magnifying and illuminating device easily slides across a menu, according to an embodiment of the presently claimed invention.

The various embodiments of the present invention will hereinafter be described in conjunction with the appended drawings, wherein like designations denote like elements.

### DETAILED DESCRIPTION

As discussed above, embodiments of the present invention relate to a magnifying device and more particularly to a menu magnifying and illuminating device as used to improve the readability of menus with small print in dim restaurant lighting.

Generally speaking, the menu magnifying and illuminating device is a small handheld magnifying tool, designed to assist with reading small/fine print on restaurant menus. The menu magnifying and illuminating device is preferably shaped similarly to a smartphone, so as to fit easily into a pocket or bag, and includes a wide magnifying screen for reading text. LED lights are optionally installed around the interior perimeter in order to illuminate the text when reading in dim restaurant lighting. A user simply slides the menu magnifying and illuminating device over a menu to magnify the small text and clearly read all menu options.

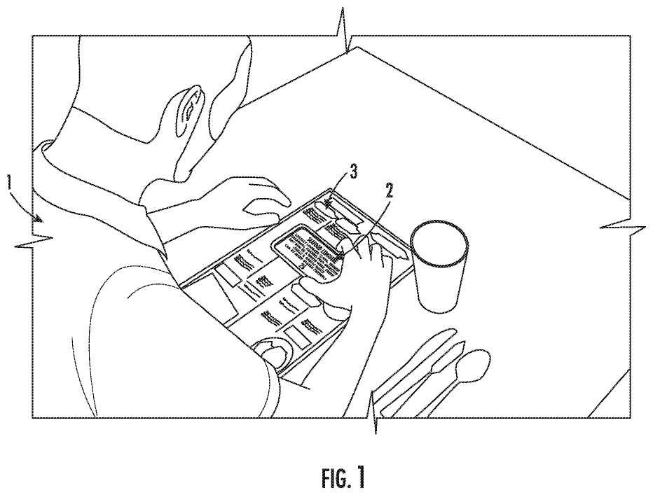

Referring to the drawings by numerals of reference there is shown in FIG. 1, a user 1 uses a menu magnifying and illuminating device 2 to magnify the text on a menu 3.

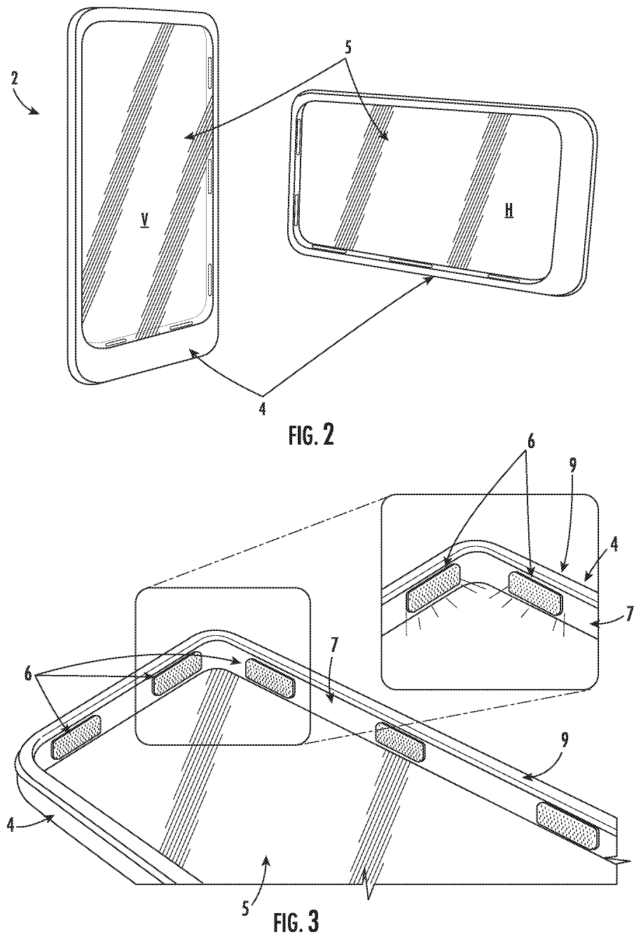

Referring now to FIG. 2, the menu magnifying and illuminating device 2 includes an outer frame 4 with a magnifying screen 5 embedded therein. The menu magnifying and illuminating device 2 can be held in a vertical V position or a horizontal H position, depending on the menu 3 orientation. The outer frame 4 is preferably rectangular in shape with curved corners, similar to the shape of most smart phones. The outer frame 4 has an opening therein. The magnifying screen 5 is embedded in the opening.

Referring now to FIG. 3, the menu magnifying and illuminating device 2 includes one or more LED lights 6 along the inner edge 7 of the frame 4. The LED lights 6 may be an strip of LED lights 6 with an adhesive on one side that adheres to the inner edge 7 of the frame 4 so that the LED lights 6 illuminate the text 8 of the menu 3. The outer frame 4 has a lip 9 that runs atop the inner edge 7, on the opposite side of the frame 4 from the magnifying lens 5.

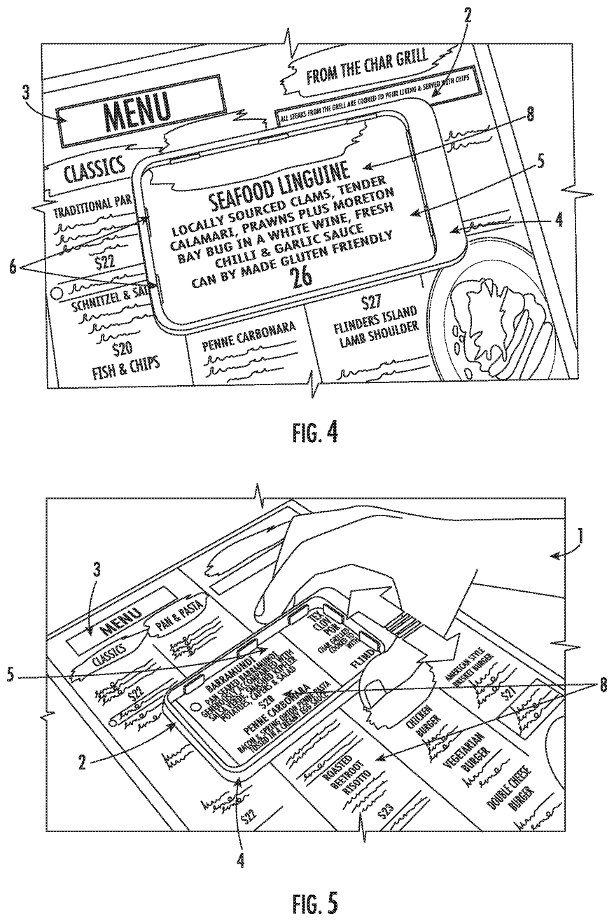

Referring now to FIG. 4, the menu magnifying and illuminating device 2 is set on the menu 3 with the lip 9 of the frame 4 in contact with the menu 3. The LED lights 6 thus cast light directly onto the text 8 of the menu 3, illuminating the text 8. The magnifying screen 5, being above the LED lights 6, magnifies the illuminated text 8 so that a user 1 can read the menu 3.

Referring now to FIG. 5, a user 1 moves the menu magnifying and illuminating device 2 by sliding it across the menu 3, stopping over any text 8 the user wishes to read through the magnifying lens 5.

The menu magnifying and illuminating device is preferably constructed of a plastic material, but any other suitable material may also be used. The menu magnifying and illuminating device may be manufactured in a variety of sizes to accommodate different styles of restaurant menus and personal preferences.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A menu magnifying and illuminating device comprising:
a. an outer frame having
i. a top surface with an opening therein; and
ii. a lip with an inner rim and an outer rim;
b. a magnifying screen,
wherein the magnifying screen is embedded in the opening of the top surface of the outer frame;
c. at least one LED light,
wherein the at least one LED light is operably connected to the inner rim of the lip of the outer frame so that the at least one LED light casts light under the magnifying screen to illuminate text.

2. The menu magnifying and illuminating device according to claim 1, wherein the at least one LED light is a strip of LED lights with a length equivalent to a perimeter of the inner edge of the lip of the outer frame.

3. The menu magnifying and illuminating device according to claim 1, wherein the outer frame has a rectangular shape with curved corners.

4. The menu magnifying and illuminating device according to claim 1, wherein the outer frame is formed of a plastic material.

5. A menu magnifying and illuminating device comprising:
a. an outer frame having
i. a top surface with an opening therein;
ii. a lip with an inner rim and an outer rim; and
iii. a rectangular shape with curved corners,
wherein the outer frame is formed of a plastic material;
b. a magnifying screen,
wherein the magnifying screen is embedded in the opening of the top surface of the outer frame;
c. a strip of LED Lights having a length equivalent to a perimeter of the inner edge of the lip of the outer frame,
wherein the at least one LED light is operably connected to the inner rim of the lip of the outer frame so that the at least one LED light casts light under the magnifying screen to illuminate text.
